(19) United States
(12) Patent Application Publication
(10) Pub. No.: US 2005/0111063 A1
(43) Pub. Date: May 26, 2005

(54) Modular scanning system for cabling systems

(76) Inventors: Alex Shar, Rishon Leszion (IL); Barak Cherches, Kibutz Ramat-Hakovesh (IL)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/963,422

(22) Filed: Oct. 12, 2004

Related U.S. Application Data
(63) Continuation of application No. PCT/IL04/00864, filed on Sep. 20, 2004.

(30) Foreign Application Priority Data
Sep. 21, 2003 (IL) 158030

(51) Int. Cl. H01B 7/36; H04N 1/04

(52) U.S. Cl. 358/514; 174/112; 358/474; 382/318

(57) ABSTRACT

Method and system for acquiring and updating the topology of a modular scanning system, in which patch panels are scanned. The result of the scanning of each panel is forwarded to a memory cell of an expander. The output of each expander is forwarded to a cell of a successive expander, and so forth, until the output of a final expander is forwarded to a master. Each scanning unit forwards unique ID data to an expander, to which said scanning unit is connected. The unique ID data is relayed from the expander to higher level expanders, all of which are connected in series with respect to one another, until reaching a second level expander, from which the ID data is forwarded to the master where it is stored. This process is repeated while the ID data replaced with neighbors' data, for allowing the master to know which scanning unit is connected to which scanning unit. Finally, the topology map is generated in the master from the collection of ID data and neighbors' data stored therein.

### RELATED APPLICATION

This application is a continuation of International Application No. PCT/IL04/000864 filed Sep. 20, 2004, which is here incorporated by reference in its entirety.

### BACKGROUND OF THE INVENTION

1. Field of the Invention

The present invention relates to the field of cabling systems. More particularly, the present invention relates to a modular scanning system capable of handling small to large scale cabling systems). The present invention relates also to a method for automatically identifying each component within the aforesaid modular scanning system, including its relative location within the topology of the aforesaid modular scanning system.

2. Prior Art

The term ‘managing’ (i.e., in connection with ‘management of cabling systems’, or ‘communication panels’, or ‘patch panel’) encompasses operations such as obtaining actual or desired, and/or monitoring the, connectivity status, or map, of a cabling system, and using desired connectivity status for guiding an operator through desirable cabling changes and indicating to the operator erroneous and unauthorized connections and disconnections of patch cords.

The term ‘Patch Panels’ refers to panels that include data and/or video/voice ports (hereinafter, briefly, “ports”), to which multiconductor cables (hereinafter referred to as ‘Patch Cords’) may be connected, for connecting between any two ports.

‘Connectivity Status’, or ‘Connectivity Map’, is an ensemble of data that indicates which patch cord's end is connected to which port in which patch panel. The connectivity status/map is normally contained within a storage array, for example, in a database.

‘Connectivity status indicator’ is an indicator, usually a light source (e.g., LED), that is located in proximity to a port. This indicator will be activated by a central management system in order to mark, or signal (to, e.g., a technician) the port in cases where that port is involved in wanted, or unwanted, connectivity changes.

The term ‘Scanning System’ refers to a system for associating a first set of ends of patch cords to a corresponding second set of ends of patch cords. This could be obtained for example by transmitting Scanning Signals via the first set of ends of patch cords, and receiving the forwarded Scanning Signals via the second set of corresponding ends of patch cords. The scanning system may contain a database, the content of which is a data representing the connectivity status, or connectivity map, of the scanned cabling system, and updated according to the transmission of the Scanning Signals. A major component in a scanning system is a Scanner, which forwards the scanning signals, interprets the received scanning signals and generates a corresponding connectivity status. A scanning system is described, for example, in U.S. 60/251,444 (“System for automatically identifying the physical location of network end devices”), in co pending Israeli Patent application No. IL 152768 (“Retrofit kit for interconnect cabling system”), and in U.S. Pat. No. 5,483,467 (“Patching panel scanner”).

By ‘structural change in a cabling system’ it is meant the addition or subtraction of ports to/from a cabling system.

Big organizations usually have large information systems that are supported by large scale cabling systems. Large cabling systems could include thousands of patch cords that are connected to several dozen patch panels. Normally, a cabling system comprises a plurality of communication panels, each of which comprises several patch panels, preferably structurally connected to form vertical structures, a plurality of patch cords, which carry information (e.g., data, audio, TV signals, etc.), being connected to patch panels. The communication panels allow flexibility in routing information from signals sources to different final users.

Some organizations might be very small, medium sized, large sized, etc., and so are their cabling systems. Therefore, it is a purpose of this invention to provide a scanning system that allows managing and controlling a cabling system of essentially any size. Other organizations are dynamic in the sense that they are subjected to changes, which changes could be accompanied by corresponding structural changes in their cabling systems. Therefore, it is another purpose of this invention to provide a scanning system that could be easily and conveniently adapted to cope with structural changes in a cabling system.

Other objects and advantages of the invention will become apparent as the description proceeds.

### SUMMARY OF THE INVENTION

The present invention provides a modular scanning system that is capable of being adapted to a cabling system of essentially any size. The present invention provides also a modular scanning system that is scalable, for allowing coping with any structural changes in a cabling system. The present invention relates also to a method for automatically identifying each component within the aforesaid modular scanning system, including its relative location in the topology of the aforesaid modular scanning system, which topology is automatically updated whenever a new/existing component is connected/disconnected to/from the modular scanning system.

Several additional terms, useful for understanding the invention, will now be defined.

The term ‘cabling site’ (or, briefly, ‘site’) used herein is an administrative term referring to one patching area, meaning that any port in a specific site could be interconnected with any other port belonging to the same specific site, but not with a port belonging to a an other site.

By ‘Master’ it is meant hereinafter a component of the modular system, the function of which is coordinating exchange of connectivity data between one or more scanners and a central management system. The master communicates data from the central management system to scanners, for signaling to an operator which ports are involved in wanted connectivity changes and for causing the scanners, whenever required, to initiate scanning sessions, for obtaining current connectivity status of the cabling system. The master also communicates data in the opposite direction, as it communicates the connectivity status from the scanners to the central management system, where the connectivity status is interpreted and a connectivity map is updated, or regenerated. The Master also communicates other types of control messages and responses between scanners and the central management system. Each Master includes one input port, which could be connected to the central management system either directly or via a data network, such as the Internet. The Master provides substantially any required number of output ports, for allowing handling as many as required cabling sites (i.e., one port being dedicated for one site). The master can communicate with the central management system, for example, via a LAN (Local Area Network), using SNMP (Simple Network Management Protocol) protocol. However, other communication arrangements and protocols could be utilized as well.

By ‘Expander’ it is meant hereinafter a component of the modular system, the function of which is to allow enlarging the number of ports in a cabling site, by cascading Expanders from the corresponding Master, in a manner that is basically hierarchical. One Expander might be connected to one or more Scanners, to one or more Expanders, or to a combination of Expanders and Scanners.

A large scale cabling system could be administratively (i.e., for management convenience reasons) divided into several sites, in which case the modular scanning system might include one Master, as many Expanders as sites (i.e., one Expander per site), and corresponding number of scanners, for scanning ports in patch panels that are connected to the respective scanners. Alternatively, the large scale cabling system can be handled as one cabling site, in which case only one Master-Expander is to be utilized.

By ‘scanning unit’ it is meant hereinafter any expander, scanner, indicator controller, and possibly other element that is part of the modular scanning system. Each scanning unit includes means, such as a silicon serial number chip manufactured by Dallas Semiconductors, for making it uniquely identifiable by another Expander. By ‘indicator controller’ is meant a controller that forwards signals to master indicators, the function of which is to indicate to, e.g., a technician, the communication panel(s) in which one or more connectivity status indicators, related to ports of patch panels, are in active mode.

The term ‘level’ refers to the relative location of each scanning unit in the topology of the modular scanning system. More specifically, by ‘level’ is meant hereinafter the location of each one of the Expanders relative to one another and relative to the Master that monitors and controls their operation. An Expander that is connected to an output port of the Master, is regarded as first level expander. If several Expanders are connected to respective output ports of the same Master, all of these Expanders are referred to as “first-level Expanders”. Likewise, an expander is regarded as a second level expander if it is connected to a first level expander. An Expander may communicate with the Master, via one or more Expanders belonging to higher levels (‘more’—two or more Expanders connected to each other in series). Each Scanner that is connected to an Expander belongs to the level of this Expander.

By ‘Dallas Chip’ it is meant herein a general name for silicon serial number integrated circuit made by Dallas Semiconductor or other companies. Each chip has a unique factory etched serial number, which allows its unique identification, and, after having such chips incorporated into scanning units and possibly into Patch panels, it allows to distinguish between the scanning units and to uniquely identify each element and patch panel. Utilizing a silicon serial number chip is an option, as the unique ID can be generated by utilizing alternative methods as well, for example, by using unique resistive combinations as identifiers.

The present invention provides a method for automatically generating a map in the Master that represents the topology of a modular scanning system monitored and controlled by the master, and updating the aforesaid map.

The apparatus of the invention is a modular scanning system comprising at least one site and preferably a plurality of sites, each site comprising
a) a plurality of scanners, each for scanning a plurality “x” of patch panels;
b) a plurality of first expanders, each receiving the output of “y” scanners;
c) optionally, a succession of pluralities of expanders, each receiving the output of expanders of the preceding succession;
d) a final expander, receiving the output of the expanders of the last of said succession, the output of said last expander being the output of the site;

The modular scanning system further comprising a master, receiving in succession the output of all the sites and being capable of drawing a map of the system and of updating it.

Typically, the expanders of each of said succession are in the number of 8, “y” is 8, and “x” is 24.

If, for example, the succession of pluralities of expanders comprises 3 pluralities, the expanders of each of said succession are 8, and “x” is 24, the master will receive from each site 3×8×24=576 input values, and the hardware of the corresponding master will be moderate. If each output will be received and registered in, say, 3 seconds, 11520 values will be received and registered by the master in one minute and 100,000 in less than 10 minutes, and in a shorter time if the pluralities of expanders in each site are more than 3. The economy of hardware compared to a master receiving the data concurrently from all panels, is obvious.

The modular scanning system of the invention, therefore, can be defined more synthetically as comprising, in addition to a number of patch panels and to a master, as hereinbefore defined, a number of sites each comprising a cascade of expanders divided in a plurality of successive levels, the output of a number of expanders in each level being the input of a single expander in the successive level. It is noted that in this definition the succession of levels goes from a first level that is closest to the scanners to a final level that is closest to the master. A succession that is verbally opposite, but substantially the same, in which the level that is closest to the master is called the first and the final level that is closest to the scanners is called the final one, may be used for descriptive purposes, and will be used in an example.

The invention also provides a method of managing a modular scanning system, in which patch panels are scanned, the result of the scanning of each panel is forwarded to a memory cell of an expander, the output of each expander is forwarded to a cell of a successive expander, and so on, until the output of a final expander is forwarded to a master.

The modular scanning system comprises the Master, one or more scanning units and patch panels, each of which has a unique ID for distinguishing between the scanning units/patch panels. Knowing the topology map of the scanning system allows the Master to cooperate with the scanning units and patch panel belonging to the site(s) monitored and controlled by this Master, and an updated topology allows the Master to know if one or more new scanning units have been connected, or existing scanning units disconnected, to/from the modular scanning system. The method allows also identifying changes (i.e., connection/disconnection of scanning units) in the topology map.

Preferably, generating the map of the topology of a modular scanning system is performed by: (a) forwarding, by each scanning unit, unique ID data to the expander to which the scanning unit is connected; (b) relaying the unique ID data from this expander to higher level expanders, all of which are connected in series with respect to one another, until reaching the second level expander, from which the ID data is forwarded to the master where it is stored; (c) repeating steps (a) and (b), with the ID data replaced with neighbors' data, for allowing the master to know which scanning unit is connected to which scanning unit; and (d) generating the topology map from the collection of ID data and neighbors' data stored in the master.

Preferably, each patch panel in the modular scanning system forwards its unique ID data to the scanner to which it is connected, for notifying the scanner of its existence. Then, the ID data of the patch panel is forwarded from the scanner to the expander to which it is connected, from which expander the ID data is relayed to higher level expanders, until reaching the master, where the ID data is stored.

Preferably, in each expander there is stored a copy of the ID data of only scanning units that are connected to its output ports. Optionally, each expander keeps a copy of every ID data that is relayed by it to a higher level expander, or to the master.

The topology map can be updated in two ways: (a) every time a new scanning unit is connected to an existing expander, or to the master, the new scanning unit forwards its ID data to the expander or to the master, in the way describe before; and (b) whenever a scanning unit is disconnected or in inactive mode of operation (i.e., switched to “OFF”) its disconnection, or inactivation, is identified by performing verification process, which comprise:
forwarding verification signals from the master to each one of its output ports, each of which is assumed to be connected directly to respective scanning unit. The connected scanning units respond to the verification signals by forwarding acknowledgement signals to the master, thereby notifying the master of their being connected to the master and in active mode of operation; and
for each expander, forwarding verification signals to its output ports, each output port is assumed to be connected to respective lower level scanning unit. Scanning units, which are connected to respective output ports, respond to the verification signals by returning acknowledgement signals to the expander, thereby notifying the expander of their being connected to the expander and in active mode of operation.

Preferably, each scanning unit forwards to an Expander of higher level, or to the master (depending to which the scanning unit is directly connected), to which the scanning unit is directly connected, a data that indicates, to the higher level expander or to the master, which of the lower level scanning units that are assumed to be connected to it, are still connected to it, and which have been disconnected (‘assumed’—according to the topology map that was known from the previous verification session).

According to one aspect of the present invention, the Master communicates with the scanning units that are connected thereto every predetermined time interval, for making sure that none of them had been switched to inactive mode, or disconnected from the modular scanning system. Failing to receive response, with respect to one or more scanning units, will cause the Master to forward corresponding alert message to the central management system.

Likewise, each Expander communicates with the scanning units (i.e., Expanders, Scanners), which are directly connected thereto, every predetermined time interval, for making sure that none of them had been switched to inactive mode, or disconnected from the modular scanning system. Failing to receive response, with respect to one or more scanning units, will cause the Expander to forward corresponding alert message to the Master, which will, in turn forward a corresponding message to the central management.

Likewise, each Scanner communicates with the patch panels, which are directly connected thereto, every predetermined time interval, for making sure of their existence prior to transmission of scanning signals to their ports. Upon identification of mismatches by a Scanner, with respect to one or more patch panels, the Scanner will forward corresponding alert message to the Master, via one or more Expanders or directly, which will, in turn, forward a corresponding message to the central management.

According to an aspect of the present invention, whenever a new scanning unit is connected to an Expander of an already working modular scanning system, the new scanning unit forwards to the expander data relating to its type and unique ID. The scanning unit keeps forwarding this data every predetermined time interval in order to allow detecting mismatches with respect to the data previously stored in the Expander.

The present invention provides also a modular scanning system for managing ports of patch panels belonging to a cabling system. The modular scanning system is manageable by a central management system, and it comprises, per cabling site:
a) One or more Scanners, to each one of them is connected a patch panel, for obtaining the connectivity status of the ports in each patch panel and controlling these ports continuously, whereby to signal, among other things, by utilizing connectivity status indicators and master indicators, wanted and unauthorized changes in said map, and if a mistake has occurred in changing said status. The Scanners are uniquely identifiable by the central management system, for allowing bidirectional communication between the central management system and the Scanners; and
b) A Master, which intermediates between the Scanners and the central management system. The Master communicates control messages, and optionally other types of data, from the central management system to the Scanners, and connectivity data relating to connectivity status from the Scanners to the central management system, where the connectivity data is interpreted and the connectivity map is updated accordingly, and, whenever an erroneous or unauthorized connection is detected by the central management system, alarm messages are generated and communicated to the Scanners via the Master, and, optionally to other means.

According to one aspect of the present invention, the modular scanning system further comprises an Expander, being a first, or highest, level Expander, that intermediates between the Master and one or more Scanners to which patch panels are connected, and allows, there through, bidirectional communication between the central management system and Scanners, for expanding the monitoring and controlling capabilities of the central management system to a larger number of ports. The first level expander could be connected to additional Expanders that form a second and lower level, etc.

According to another aspect of the present invention, the modular scanning system further comprises additional one or more Expanders, one of which is connected to the first level Expander and all of which are connected to one another, essentially in hierarchical manner to form essentially two or more levels, wherein one or more Expanders at each level are connected to one or more Expanders at a higher level, and to Scanners to which patch panels are connected, and/or to Expanders at a lower level. Each one of the Expanders is capable of bidirectional communication with, and is uniquely identifiable by, the central management system.

Preferably, the Master communicates with the central management system via a data network. Alternatively, the Master communicates with the central management system directly; that is, by directly connecting the Master to the central management system.

According to an aspect of the present invention, the functionalities of the Master and the Expander are combined in a Master-Expander, which Master-Expander is capable of handling one Site that could be as large as required.

Preferably, each one of the patch panels includes a ‘Dallas chip’ that allows the central management system to uniquely identify individual patch panels, and, thereby, to identify the type and model of each patch panel, in order for the central management system and/or Master to know in addition to the number and order of ports that are included in each one of the patch panels, the exact type of the patch panel (e.g. UTP/STP, etc) and preferably the unique ID of the panel for maintenance capabilities and for generating the topology.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 schematically illustrates an exemplary topology of a modular scanning system, according to the present invention;

FIG. 2 schematically illustrates typical arrangements of scanning units for coping with different requirements of different cabling sites, according to the present invention;

FIG. 3 illustrates the levels of an exemplary topology, according to the present invention; and

FIG. 4 schematically illustrates the auto-recognition process, according to a preferred embodiment of the present invention.

### DETAILED DESCRIPTION OF PREFERRED EMBODIMENTS

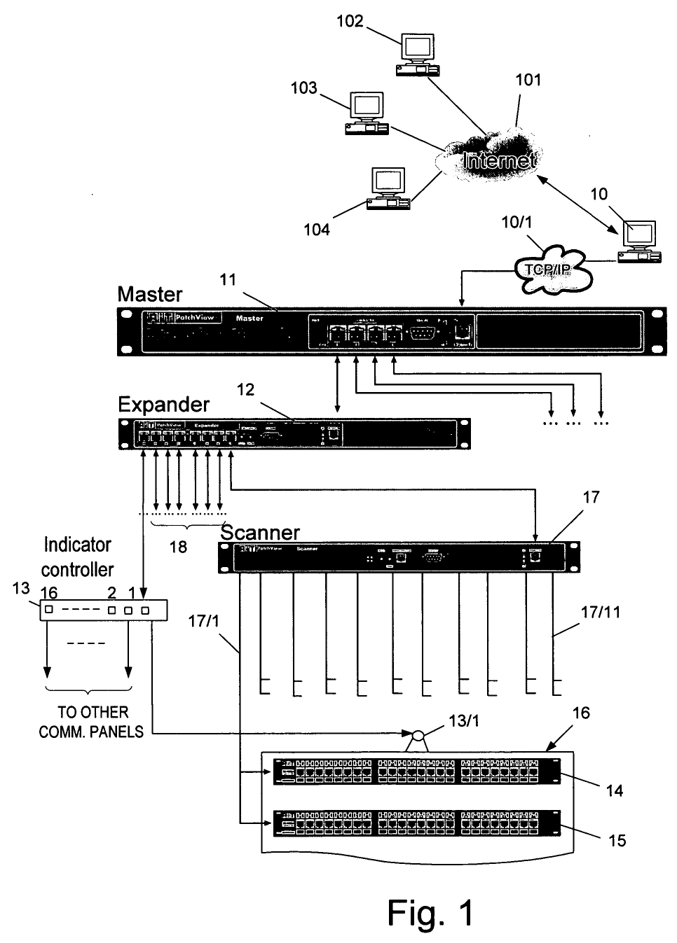

FIG. 1 schematically illustrates a general layout and functionality of the modular scanning system, according to the present invention. Central management system 10 cooperates with one master unit (11) via data network 10/1. Central management system 10 may communicate with Scanner 17 via Master 11 and Expander 12, and the communication may include forwarding control messages from the central management system 10 to Scanner 17, causing Scanner 17, among other things, to initiate scanning sessions. Each scanning session includes emission of scanning signals from Scanner 17 to ports residing within one communication panel, and receiving scanning signals from corresponding ports in the same, or different, communication panel(s). For example, Scanner 17 may forward scanning signals via channel 17/1 (normally a flat cable that connects outputs of a Scanner to patch panels) to the ports of patch panels 14 and 15 that reside within communication panel 16, and receive scanning signals via the same channel (i.e., 17/1) and/or via; e.g., channel 17/11 that could be connected to ports residing in the same communication panel (i.e., 16) or in different communication panel(s).

By utilizing scanning signals, Scanner 17 detects the connectivity status of the ports that are monitored by Scanner 17, and forwards a data relating to the connectivity status to Master unit 11, via expander 12, which, in turn, forwards that data to central management system 10. Next, central management system 10 updates a connectivity map that is contained in, e.g., a database according to the last connectivity status that was forwarded to central management system 10 by Scanner 17.

Scanner 17 is normally capable of monitoring twenty four patch panels, such as patch panels 14 or 15, each of which having normally 24 ports. However, a Scanner could be designed to monitor different numbers of patch panels/ports. In general, the more patch panels there are in a cabling system, the more Scanners are required. Accordingly, other Scanners, such as Scanner 17, could be added to the modular scanning system. Reference numeral 18 denotes optional connections of additional Scanners to Expander 12.

Optionally, Master unit 11 might distribute control messages, via Expander 12, to indicator controllers such as indicator controller 13, for signaling to an operator which communication panels are involved in wanted, or unwanted, connectivity changes. For example, Master 11 may forward a control message for causing indicator controller 13 to forward a signal to master indicator 13/1 for signaling to an operator (not shown) that wanted or unwanted connectivity changes were/are made in communication panel 16.

More than one Master could communicate with central management system 10, though only one is shown (i.e., 11). Master unit 11 could be connected to four Expanders (only one is shown, 12). Each one of the Expanders could be further connected to eight devices, which could be Scanners, other Expanders, indicator controllers, or some combination thereof.

Each one of the scanning units (i.e., Masters, Expanders, Scanners and patch panels) includes a “Dallas chip”, for making them uniquely identifiable by central management system 10. This way, central management system 10 knows the number of the scanning units and the type of each scanning unit in the modular scanning system and the relative location of each scanning unit in the modular scanning system. The latter feature allows central management system 10 to address, on selective basis, specific scanning units.

Some of the functionality of central management system 10 and Master 11 could be manually and locally (i.e., at close proximity to the Scanner) performed by an operator, by operating a control pad, such as control pad 19, which is connected to a Scanner such as Scanner 17. Control pad 19 allows an operator (not shown) to locally interact with the modular scanning system and patch panels. For example, control panel 19 allows an operator to carry out test, maintenance and configuration procedures, with respect to every scanning unit and patch port in the site, including checking the connectivity status indicator of every port in every patch panel. In addition, control pad 19 allows an operator to perform connectivity changes. If the actual modular scanning system includes more than one Scanner, such as Scanner 17, control pad 19 could be moved from one Scanner to another Scanner, or, alternatively, several control pads could be simultaneously connected to several Scanners, for allowing several operators to independently perform various interactions with the modular scanning system and patch panels (see a description relating to FIG. 5).

The modular scanning system is scalable, because additional scanners and, if required expanders, can be conveniently added to an existing modular scanning system, to allow the master to handle additional patch panels. Every addition, removing or relocation, of a scanning unit results in automatic updating of the topology in the master.

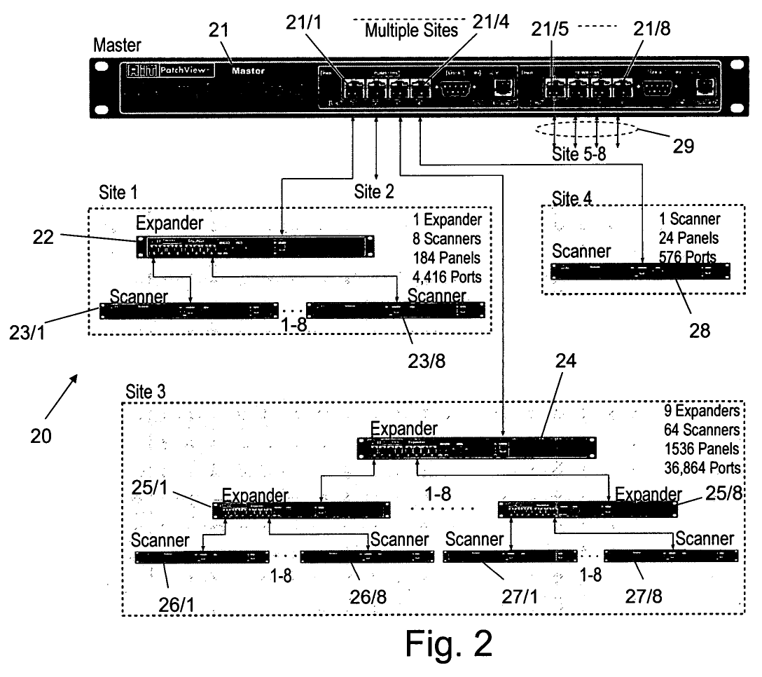

FIG. 2 schematically illustrates typical arrangements of scanning units for coping with different requirements of different cabling sites, according to the present invention. Exemplary modular scanning system 20 comprises several scanning units; that is, Master 21, several Expanders, such as Expander 22, and several Scanners, such as Scanner 28, which are arranged for handling several sites, such as Site-1. Master 21 includes eight ports (i.e., 21/1 to 21/8) for allowing it to handle up to eight sites. Only exemplary sites 1, 3 and 4 are shown, for illustrating typical modular scanning solutions for different cabling requirements. Site-4 is the simplest case, because it involves a relatively small cabling system, which requires only one Scanner (i.e., 28). Since exemplary cabling Site-4 is not likely to have more than 576 ports, there is no need for an Expander, and Scanner 28, which is capable of handling up to 576 ports, is connected directly to (exemplary port 21/4 of) Master 21. If there is a need to extend the cabling system of Site-4 (i.e., adding additional ports), one Expander, or several Expanders, could be easily added, as shown in the configuration of Site-1 or Site-3, respectively (i.e., Expander 22, or 24 and 25, respectively). Of course, the actual number of the Expanders depends on the actual number of the total ports of the extended cabling site.

Site-2, which is a medium-sized cabling system (i.e., in comparison to Sites-4 and 3), requires one Expander (i.e., 22), to which a maximum of eight Scanners (i.e., 23/1 to 23/8) could be connected, for allowing handling up to 4,416 ports (i.e., in a case that each Scanner handles 24 patch panel, each including 24 ports).

Site-3, which is the largest cabling system (i.e., in comparison to Sites-4 and 1), requires several Expanders that are arranged in levels. The first, and highest, level Expander (i.e., Expander 24) is connected to exemplary port 12/3 of Master 21. Expander 24 includes eight ports to which up to eight additional Expanders (i.e., 25/1 to 25/8), which form a second level of Expanders, could be connected. To each one of the second level Expanders 25/1 to 25/8 could be connected up to eight Scanners. For example, to Expander 25/1 could be connected Scanners 26/1 to 26/8. Likewise, to Expander 25/8 could be connected Scanners 27/1 to 27/8.

Master 21 communicate with a central management system, directly or via a data network. Both the central management system and data network are not shown in FIG. 2.

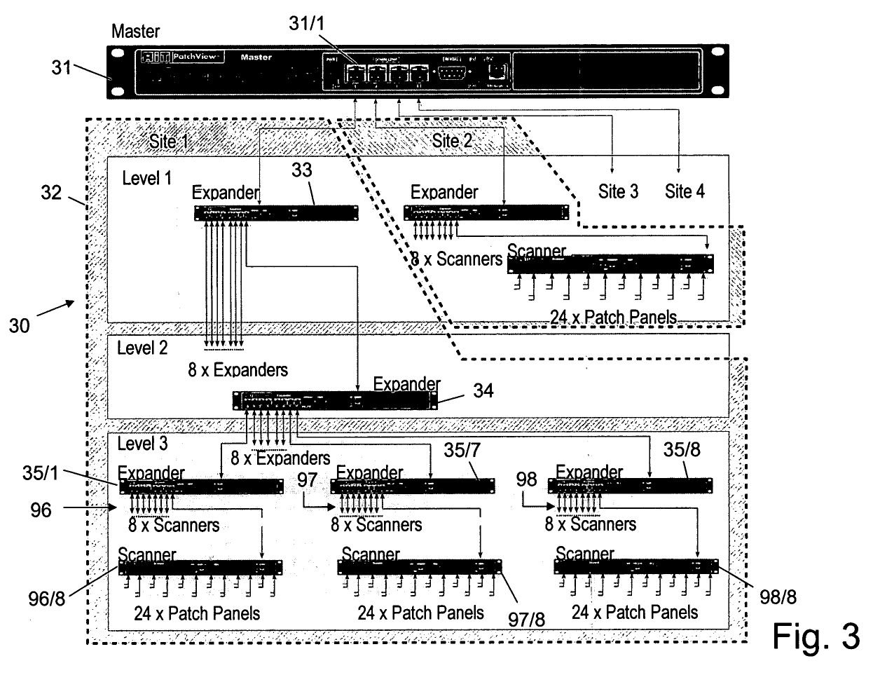

FIG. 3 illustrates the principle of establishment of Expanders' levels, according to the present invention. In order to simplify the description, only scanning units of Site-1 (i.e., reference numeral 32) will be referred to herein below. Exemplary port 31/1 of Master 31 is connected to a first level (i.e., the highest level) Expander 33. Next, to the outputs of Expander 33 could be connected second-level (i.e., lower level) Expanders, such as second-level Expander 34. To the outputs of second level Expander 34 could be connected as many as eight third-level (i.e., more lower level) Expanders, such as third-level Expanders 35/1 to 35/8, which could be eventually connected to corresponding Scanners. Of course, if the size of the cabling system so requires, or there is a need to extend an existing cabling system, additional lower levels of Expanders could be easily and conveniently added to modular scanning system 30. For example, one or more of the eight Scanners 96 (only one shown, 96/8), and/or one or more of the eight Scanners 97 (only one shown, 97/8), and/or one or more of the eight Scanners 98 (only one shown, 98/8), could be replaced by Expanders, in which case the added Expanders will form a forth-level of Expanders. A level could be considered as a ‘level’ only if it includes at least one Expander. A level may include only Expanders, as is shown with respect to levels 1 and 2 of Site-1 (32), or a combination of Expanders and Scanners, as shown with respect to level 3 of Site-1 (32).

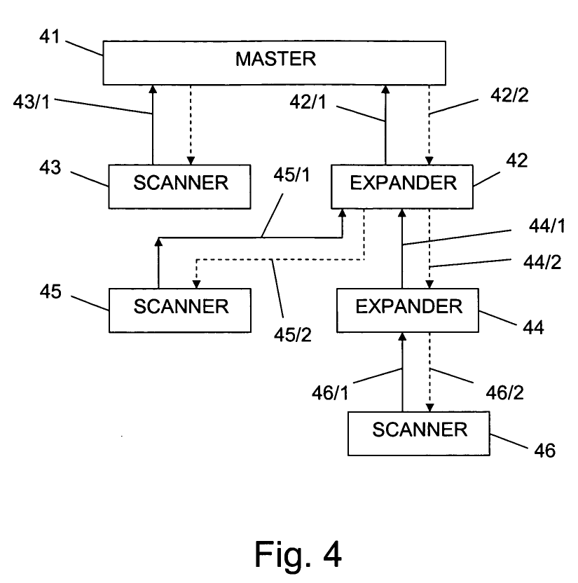

FIG. 4 schematically illustrates the auto-recognition principles, according to a preferred embodiment of the present invention. FIG. 4 shows a simple exemplary topology that will facilitate the understanding of the auto-recognition principles. The exemplary topology includes master 41 and four scanning units 42 to 45. Scanning units 42 and 44 are expanders, and scanning units 43 and 45 are scanners, to which one or more patch panels can be connected, whose connectivity status is to be monitored and controlled by master 41, or by a central managing unit that is directly or indirectly connected to master 41 in the way described in connection with FIG. 1. As described before, any combination of scanning units can be connected to master 41. For example, the scanning units can be an expander, such as expander 42, and a scanner, such as scanner 43. Master 41 is regarded as the first, and highest, level. Being connected to master 41, scanner 43 belongs to the first level of master 41. Expander 42 forms the second level, which is regarded as a lower level with respect to master 41. Being connected to second level expander 42, scanner 45 also belongs to the second level. Expander 44 forms the third level because it is connected to the output port (not shown) of a second level expander (42). Being connected to expander 44, scanner 46 belongs to the third level expander 44.

Each one of the exemplary scanning units 42 to 46 includes a unique ID data that allows, among other things, distinguishing one scanning unit from the other scanning units. The ID data of every scanning unit is forwarded to master 41, where it stored.

Each scanning unit forwards its ID data to the expander to which it is connected. This expander relays the ID data to a higher level expander, to which it is connected, and the latter expander relays the ID data to a higher level expander, and so on, until the ID data reaches the second level expander, which forwards the ID data to master 41. Referring to FIG. 6, scanner 45 forwards (45/1) its ID data to second level expander 42, which relays (42/1) this ID data, and also its own ID data, to master 41. Scanner 46 forwards (46/1) its ID data to third level expander 44, to which it is connected, and third level expander 44 relays (44/1) this ID data, and also its own ID data, to second level expander 42, which forwards (42/1) the ID data of scanner 46 and the ID data of expander 44 and its own ID to master 41. Scanner 43 forwards (43/1) its ID data directly to master 41.

The identification (ID) data contains information such as: (1) Serial number of the scanning unit, (2) operation mode (3) Type of scanning unit, (4) software version, etc.

Each one of the output ports of each scanning unit might be potentially connected to a lower level scanning unit, and each scanning unit includes a data (herein ‘neighbors’ data’) that specifies if there is any scanning unit that is connected to one of its output ports. The neighbors' data can be obtained automatically, for example, by forwarding, by each scanning unit corresponding inquiry signals to its output ports. Each one of the scanning units then forwards its neighbors' data to master 41, essentially in the same way it forwards its, and potentially others, ID data to master 41.

Based on the collection of ID data and neighbors' data, which are stored in master 41, master 41 generates topology map of the modular scanning system, after which master 41 ‘knows’ which scanning unit is connected to which scanning unit, how many branches there are in the cabling site, what are the types and serial numbers of the scanning units, etc.

After the generation of the topology map of the modular scanning system, master 41 is updated with every new scanning unit that is connected to modular scanning system. The new scanning unit (not shown) forwards its ID data to the expander to which it is connected, and this ID data reaches master 41 in the same manner as described before. The topology map is updated by master 41 accordingly.

If a scanning unit is disconnected, or inactivated, the fact of its disconnection, or inactivation, is forwarded to master 41 as will be described now. Each one of the scanning units 42 to 46 forwards to its output ports inquiry signals, for identifying whether scanning unit, which are assumed to be connected to one of its output ports (‘assumed’ according to last known topology map), are still connected, or, if they are, if they are in inactive mode of operation. For example, expander 42 forwards (44/2) inquiry signal to expander 44, and also (45/2) to scanner 45. Likewise, expander 44 forwards (46/2) inquiry signal to scanner 46. If a scanning unit fails to receive a response at one, or more, of its output ports, the scanning unit notifies that fact to master 41 by relaying to master 41 a corresponding data, via the corresponding expanders, from a lower level expander to a higher level expander. For example, if, for some reason, scanner 46 is disconnected, or switched to inactive mode of operation, expander 44 will not receive a response after forwarding (46/2) the inquiry signal, and will update its neighbors' data. Expander 44 will, then, forwards its updated neighbors' data to master 41, which can respond by updating the topology map, or by generating alert signal, or both updating the topology map and generating alert signal. As a result of the disconnection/inactivation of scanner 46, master 41 excludes the (disconnected/inactivated) branch, which includes scanner 46 and patch panels that can be potentially connected to it (not shown), for optimizing the scanning procedure.

The neighbors' data of each scanning unit can be updated by forwarding the corresponding inquiry signals each predetermined time interval, or according to any preferable criteria.

The principle of using ID data for obtaining the topology of a modular scanning system can be adapted to modular scanning systems having their scanning units connected in series, in parallel, or alternatively, some of the scanning units of a modular scanning might be connected in series, and the other scanning units might be connected in parallel.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. Method for acquiring and updating the topology of a modular scanning system, in which patch panels are scanned, the result of the scanning of each panel is forwarded to a memory cell of an expander, the output of each expander is forwarded to a cell of a successive expander, and so on, until the output of a final expander is forwarded to a master.

2. Method according to claim 1, which comprises:
a) forwarding, by each scanning unit, unique ID data to an expander to which said scanning unit is connected;
b) relaying said unique ID data from said expander to higher level expanders, all of which are connected in series with respect to one another, until reaching a second level expander, from which said ID data is forwarded to said master where it is stored;
c) repeating steps (a) and (b), with the ID data replaced with neighbors' data, for allowing said master to know which scanning unit is connected to which scanning unit; and
d) generating, in said master, the topology map from the collection of ID data and neighbors' data stored in said master.

3. Method according to claim 2, further comprising forwarding, by each patch panel in the modular scanning system its unique ID data to the scanner to which it is connected, for notifying said scanner of its existence, after which the ID data of said patch panel is forwarded from said scanner to an expander to which it is connected, said expander relaying said ID data to higher level expanders, until reaching the master, where the ID data is stored.

4. Method according to claim 3, wherein in each expander there is stored a copy of only the ID data of scanning units, and/or patch panels that are connected to its output ports.

5. Method according to claim 3, wherein each expander keeps a copy of every ID data that is relayed by it to a higher level expander, or to the master.

6. Method according to claim 3, wherein the topology map is updatable in the following ways:
(a) whenever a new scanning unit is connected to an existing expander, or to the master, said new scanning unit forwarding its ID data to the expander, to which said new scanning unit is connected, and said ID data being relayed form said expander to higher level expanders until reaching said master; or directly to said master;
(b) identifying whenever a scanning unit is disconnected or in inactive mode of operation by performing verification process, comprising:
b.1) forwarding verification signals from said master to each one of its output ports, for generating or updating its neighbors data, and for making sure that none of the scanning units, which are assumed to be connected to respective output ports, had been switched to inactive mode, or removed, or disconnected, said master initiating alert message after failing to receive acknowledgement from any of said scanning units; and
b.2) for each expander, forwarding verification signals from said expander to each one of its output ports, for generating or updating its neighbors data and for making sure that none of the scanning units, which are assumed to be connected to respective output ports, had been inactivated, or disconnected, said expander noticing said master if a scanning unit is disconnected, or inactivated, by forwarding to said master, if required via higher level expanders, a corresponding message, said master responding to said notice by initiating alert message;
b.3) for each scanner, forwarding verification signals from said scanner to each one of its output ports, for generating or updating its neighbors data and for making sure that none of the patch panels, which are assumed to be connected to respective output ports, had been disconnected, said scanner noticing the expander, to which said scanner is connected, if a patch panel is disconnected, by forwarding to said expander a corresponding message, said expander relaying said message to said master, if required via higher level expanders, and said master responding by initiating alert message; and
c) forwarding, by each scanner, its neighbors data to the corresponding expander, said expander relaying the neighbors data of the scanners and their own neighbors data, to a higher level Expander, which further relays the neighbors data relayed to it, and its own neighbors data, to a higher level expander, until all of the neighbors data reaches the master, where it is stored, said master generating the topology map based on the ID data and neighbors data that are stored therein.

7. Method according to claim 2, further comprising reading, from each on one the scanners, from the patch panels connected thereto a data relating to the type of said patch panels and to the number of rows thereof.

8. Method according to claim 6, wherein the Master forwards verification signals to the scanning units directly connected thereto every predetermined time interval.

9. Method according to claim 6, wherein each Expander forwards verification signals to the scanning units, which are directly connected to its output ports, every predetermined time interval.

10. Method according to claim 6, wherein each Scanner forwards verification signals to the patch panels, which are directly connected to its output ports, every predetermined time interval.

11. Modular scanning system, which comprises, in addition to a number of patch panels and to a master, a number of sites each comprising a cascade of expanders divided in a plurality of successive levels, the output of a number of expanders in each level being the input of a single expander in the successive level.

12. System according to claim 11, wherein each site comprises:
a) a plurality of scanners, each for scanning a plurality “x” of patch panels;
b) a plurality of first expanders, each receiving the output of “y” scanners;
c) optionally, a succession of pluralities of expanders, each receiving the output of expanders of the preceding succession;
d) a final expander, receiving the output of the expanders of the last of said succession, the output of said last expander being the output of the site; and
e) the modular scanning system further comprising a master, receiving in succession the output of all the sites and being capable of drawing a map of the system and of updating it.

13. System according to claim 11, wherein the expanders of each of the succession are 8, “y” is 8, “x” is 24.

14. System according to claim 11, which comprises:
a) One or more Scanners, to each one of them is connected one or more patch panels, said scanners obtaining the connectivity status of the ports in each patch panel and controlling these ports continuously, whereby to signal, among other things, by utilizing connectivity status indicators and master indicators, wanted and unauthorized changes in the connectivity map related to said patch panels, and if a mistake has occurred in changing said status, said Scanners being uniquely identifiable by said central management system, for allowing bidirectional communication between said central management system and said Scanners; and
b) A Master, being the first and highest level, which intermediates between said Scanners and said central management system, said Master communicating control messages, and optionally other types of data, from said central management system to said Scanners, and connectivity data relating to connectivity status from said Scanners to said central management system, where the connectivity data is interpreted and the connectivity map is updated accordingly, and, whenever an erroneous or unauthorized connection is detected by said central management system, alarm messages are generated and communicated to said Scanners via said Master, and, optionally to other means, said Master being uniquely identifiable by the central management system, for allowing bidirectional communication between said central management system and said Master, and, there through, between said central management system and said Scanners, said scanners forwarding to said master their unique ID data from which said master generates the topology of said system.

15. System according to claim 14, in which the modular scanning system further comprising an Expander, being a second level Expander, that intermediates between the Master and one or more Scanners to which patch panels are connected, and allows, there through, bidirectional communication between the central management system and said Scanners, for allowing expanding the monitoring and controlling capabilities of said central management system to a larger number of patch panels, said first level expander is connectable to additional Expanders and/or scanners, said patch panels forwarding to said scanners their ID data, said scanners forwarding the ID of said patch panels, and their own ID data, to said expander, and said expander relaying said ID data of said patch panels and said scanners to said master.

16. System according to claim 15, in which the modular scanning system further comprising additional one or more Expanders, one of which is connected to the second level Expander and all of which are connected to one another, essentially in hierarchical manner to form additional levels, in which one or more Expanders at each level are connected to one or more Expanders at a higher level, and to Scanners to which patch panels are connected, and/or to Expanders at a lower level, each one of said Expanders is capable of bidirectional communication with, and is uniquely identifiable by, the central management system.

17. System according to claim 15, in which the Master communicates with the central management system via a data network.

18. System according to claim 14, in which each one of the patch panels, scanners and expanders includes a Dallas chip that allows the central management system to uniquely identify them.

19. System according to claim 14, in which each expander and scanner forwards verification signals to its out ports, for verifying whether a respective patch panel, scanner or expander, which are assumed to be connected to the respective ports, are disconnected or inactivated, each one of said output ports receiving, in response, acknowledge signals if the respective patch panel, scanner or expander is still connected, otherwise, the expander and scanner, which forwarded the verification signals notifying the master of a disconnected patch panel, scanner or expander, said master updating the topology map and initiating corresponding alert message.

20. System according to claim 14, in which whenever a new patch panel, or scanner, or expander, is connected to the system, its ID data is automatically forwarded to the master, or, if required, by relaying it from one expander to a higher level expander until said ID data reaches the master.
